(19) United States
(12) Patent Application Publication
(10) Pub. No.: US 2002/0004362 A1
(43) Pub. Date: Jan. 10, 2002

(54) Countersink bit for glass

(75) Inventor: Rainer Lubke, Hilden (DE)

Correspondence Address: THE FIRM OF KARL F ROSS, 5676 RIVERDALE AVENUE, PO BOX 900, RIVERDALE (BRONX), NY, 10471-0900, US

(73) Assignee: WENDT GMBH

(21) Appl. No.: 09/896,668

(22) Filed: Jun. 29, 2001

(30) Foreign Application Priority Data
Jul. 5, 2000 (DE) 10032036.8

(51) Int. Cl. B02C 23/18

(52) U.S. Cl. 451/488; 451/540; 451/541

(57) ABSTRACT

A countersink bit for glass has a shaft extending along and rotatable about an axis, a head fixed to the shaft and having a frustoconical surface centered on the axis, a layer of grinding material on the surface, and an axially relatively incompressible plastic body capable of transmitting torque between the surface and the shaft. The plastic body has good damping capabilities so that any tendency of the head to vibrate or chatter is largely eliminated.

### FIELD OF THE INVENTION

The present invention relates to a countersink bit. More particularly this invention concerns such a bit used to form a countersink at a bore in a glass workpiece.

### BACKGROUND OF THE INVENTION

In order to mount a piece of glass flush it is standard to form the glass piece with a plurality of normally cylindrical bores and then cut a countersink in the outer face of the glass at each bore. This way a fitting of the Multipoint™ or Multiplex™ type can be secured to the glass which will not project appreciably beyond the outer face of the glass.

The standard countersink bit comprises a steel shaft extending along and centered on an axis and, at one end, a head formed unitarily with the shaft and having a conically or frustoconically tapered surface also centered on the axis. The tapered surface is provided with an abrasive layer, for instance of carbide or diamond particles. Such a tool is held in a chuck and rotated at high speed about its axis while being pushed axially into the bore, thereby forming the desired frustoconical countersink. This type of tool is distinguished from a simpler deburring tool which is used merely to ease the outer edge of a bore, not to form a relatively deep countersink intended to receive a fitting head.

The problem with forming a countersink in a glass workpiece is that, due to the extreme hardness of the workpiece, it is difficult to prevent the workpiece from jumping about somewhat in the bore, a phenomenon known as chatter. If chatter is excessive, the workpiece is chipped or cracked. When several holes have to be bores in an expensive workpiece, for instance a shaped piece of laminated glass intended for use as a motor-vehicle sun roof, such damage at any of the holes to be countersunk renders the entire workpiece unusable.

There are several likely causes for this chatter effect:

the relatively great axial distance between the chuck and the machining surface of the bit head,

the considerable radial spacing between the shaft axis and the machining surface,

torsional deformations of the shaft,

flexibility of the frame on which the chuck is mounted, and

instability of the support holding the workpiece.

These all can lead to imperfect alignment of the tool axis with the bore axis and offcenter point stresses that can lead to undesired chipping or cracking. Furthermore the equipment holding the chuck and rotating the bit all have a certain amount of elasticity that can result in vibration when the rotating tool engages the workpiece. When the vibration is at or near a resonant frequency of the structure, the resultant chatter can rapidly destroy the workpiece and bit.

### OBJECTS OF THE INVENTION

It is therefore an object of the present invention to provide an improved countersink bit for glass.

Another object is the provision of such an improved countersink bit for glass which overcomes the above-given disadvantages, that is which forms a relatively deep frustoconical countersink without any significant likelihood of chipping or cracking the workpiece.

### SUMMARY OF THE INVENTION

A countersink bit for glass has according to the invention a shaft extending along and rotatable about an axis, a head fixed to the shaft and having a frustoconical surface centered on the axis, a layer of grinding material on the surface, and an axially relatively incompressible plastic body capable of transmitting torque between the surface and the shaft. The plastic body has good damping capabilities so that any tendency of the head to vibrate or chatter is largely eliminated. Thus the vibrations that inevitably develop in the equipment not transmitted to the grinding surface. Such a bit can therefore be used in a standard countersinking system without any modifications to the equipment.

The advantages of the system of this invention are chiefly due to how the vibrations in the drive and mount for the drill bit are eliminated and damped out by short-term elastic deformations of the plastic body. Vibrations will therefore go away rather than get worse, being in effect absorbed in the plastic body so the grinding surface stays true and does not chatter on the workpiece. Since the deformations of the plastic body are easily confined to below its elastic limit, they do not permanently deform or damage it.

The plastic body can be an artificial rubber of high Shore hardness, a polyamide, polytetrafluorethylene, or the like. The vibrations it absorbs are converted, at worst, to some heat that is easily dissipated. The equipment normally has a certain amount of elasticity due to the mounting of the chuck holding the bit and the drive chain, and this elasticity encourages the development of vibrations that are damped out and eliminated by the plastic body of this invention. In fact the damping body normally makes the diamond grit stay sharp for the full service life of the tool, as peak loads are reduced.

The body according to the invention forms the frustoconical surface and the grinding-material layer is fixed directly to the body. In addition the body and shaft are formed with passages opening at the surface and through which a coolant liquid is forced. The passages include a central axially extending feed passage in the shaft and a plurality of smaller branch passages extending from the central passage to the surface. The surface is formed with a plurality of radially open pockets into which the branch passages open. These pockets are radially extending and outwardly open grooves. In order to distribute the coolant, the branch passages open into the respective grooves at different spacings from the axis. This coolant also serves to flush out particles freed from the surface by the diamond grit, preventing them from clogging the grit and reducing abrasiveness.

The frustoconical surface carrying the grit layer has according to the invention an apex angle of more than 0° and less than 180°, more particularly between 110° and 130°.

In a particularly simple embodiment of the invention the body forms the entire head. Alternately the head and shaft have axially interfitting and complementary formations and can therefore be made of different materials. The formations include an axial projection of predetermined axial length, an axially open seat of predetermined axial depth shorter than the length and having a rim, and a shoulder fixed relative to the projection and bearing axially on the rim. The head and shaft form at a base of the seat and end of the projection a chamber. The shaft is formed of metal with an axial large-diameter feed passage opening into the chamber and the head is formed with a plurality of smaller-diameter branch passages extending from the chamber to the surface. As described above, a coolant is forced through the passages to the surface.

In the system described immediately above an adhesive between the rim and the shoulder serves to secure the head on the shaft. In addition a plurality of set screws engaged radially through the seat into the projection further lock it in place.

The shaft in accordance with the invention can be further unitarily formed centered on the axis with a boring tool projecting axially past the head. Furthermore the layer of grinding material is adhesively secured to the surface and the layer of grinding material is sintered.

### BRIEF DESCRIPTION OF THE DRAWING

The above and other objects, features, and advantages will become more readily apparent from the following description, reference being made to the accompanying drawing in which:

FIG. 1 is a partly diagrammatic and axially sectional view of a countersinking system according to the invention;

FIG. 1a is a diagram illustrating the instant invention;

FIG. 2 is a large-scale end view of the countersink bit in accordance with the invention;

FIG. 3 is a partly sectional and diagrammatic side view of another countersink took according to the invention; and

FIG. 4 is a view like FIG. 1 of yet another countersinking system in accordance with the invention.

### SPECIFIC DESCRIPTION

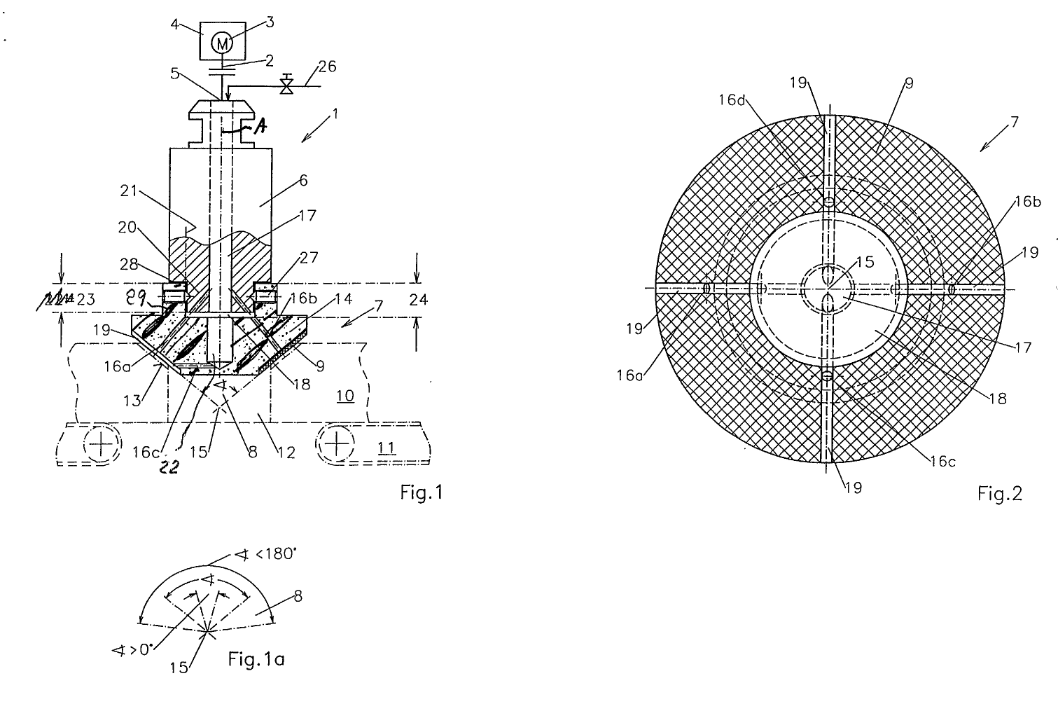

As seen in FIGS. 1 and 2 a countersink bit 1 according to the invention is centered on an axis A and has a cylindrical steel shaft or spindle 6 whose rear end 5 is secured in a chuck illustrated schematically at 4 for rotation by a motor 3 about the axis A and advance by a drive 2 along the axis A. A glass workpiece 10 has a cylindrical bore 12 that is coaxial with the tool 1 and that is to be formed with a frustoconical countersink 13 also centered on the axis A. This workpiece 10 is supported on a two-part conveyor 11.

The tool 1 has a head 7 here having a body 14 formed of a material that is relatively incompressible but deformable, such as a rubber of high Shore hardness, a polyamide, or polytetrafluorethylene with good vibration-damping characteristics. The head 7 has a frustoconical outer face with an apex angle 8 centered on a point 15 and equal as shown in FIG. 1a to more than 0° and less than 180°, here about 120°. This end surface is provided with a layer 9 of carbide grit and is formed with four angularly equispaced outwardly open grooves 19 serving for conducting a coolant and flushing liquid to the interface between the grit layer 9 and the countersink 13 being formed.

The shaft 6 has a small-diameter forward projection 20 of cylindrical shape having an axial dimension 23 and the head 7 is formed with a rearwardly directed cylindrical collar 29 that forms a cylindrical recess or seat 21 that fits snugly around the projection 20 and that has a depth 24 equal to slightly more than the projection length 23. A shoulder of the shaft 6 thus bears via a layer of adhesive 28 on the rear end of the collar 20 to solidly support the head 7 on the shaft 6. In addition a plurality of angularly spaced set screws 27 extend radially through the collar 29 and have inner ends that engage in the projection 20 to lock the head 7 on the shaft 6. All torque from the motor 4 and shaft 6 is thus transmitted via the damping body 14 to the grit layer 9.

The interior of the shaft 6 is formed with a large-diameter axially throughgoing passage 17 that opens into a distributing chamber 18 formed between the floor of the seat 21 and the end of the projection 20. The head body 14 is formed with a central axial blind bore open toward and aligned with the passage 17, and with four smaller-diameter branch passages 16a through 16d communicating between this bore 22 or the chamber 18 and the respective grooves 19. The rear end of the passage 17 is connected to a supply 26 of a coolant liquid, normally water for glass. As shown in FIG. 2, the outer ends of the passages 16a and 16b open generally equidistant between the ends of the diametrally opposite grooves 19 they feed, while the passages 16c and 16d open into the radial inner ends of the respective grooves 19.

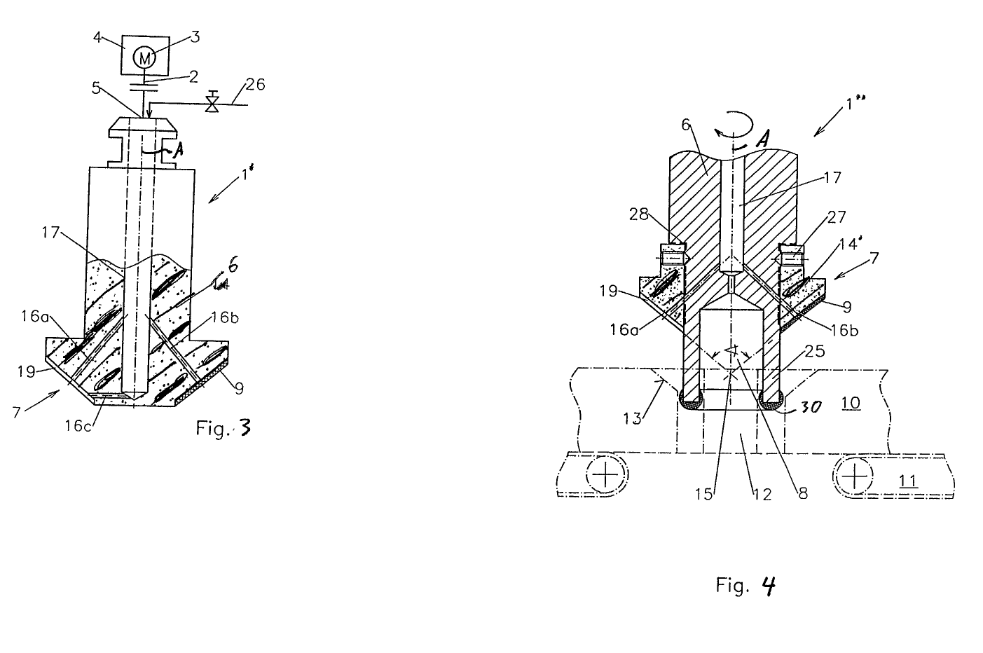

FIG. 3 shows a tool 1′ where the head 7 and shaft 6 are both formed of the relatively incompressible plastic, unitarily with each other. This eliminates the need for the interfitting formations 20 and 21 and the set screws 27.

In FIG. 4 the shaft 6 of the tool 1″ is formed centered on the axis A with a cylindrical forward extension 26 having a grit bead 30 on its front end so that this part 25 can itself cut the bore 12. Thus the same tool forms both the cylindrical bore 12 and the frustoconical countersink 13. In this case the body 14′ forming the head 7 is a ring surrounding the shaft 6.

I claim:

1. A countersink bit for glass, the bit comprising:
a shaft extending along and rotatable about an axis;
a head fixed to the shaft and having a frustoconical surface centered on the axis;
a layer of grinding material on the surface; and
an axially relatively incompressible plastic body capable of transmitting torque between the surface and the shaft.

2. The countersink bit defined in claim 1 wherein the body forms the frustoconical surface and the grinding-material layer is fixed directly to the body.

3. The countersink bit defined in claim 2 wherein the body and shaft are formed with passages opening at the surface, the bit further comprising
means for forcing a coolant liquid through the passages to the surface.

4. The countersink bit defined in claim 3 wherein the passages include a central axially extending feed passage in the shaft and a plurality of smaller branch passages extending from the central passage to the surface.

5. The countersink bit defined in claim 4 wherein the surface is formed with a plurality of radially open pockets into which the branch passages open.

6. The countersink bit defined in claim 5 wherein the pockets are radially extending and outwardly open grooves.

7. The countersink bit defined in claim 6 wherein the branch passages open into the respective grooves at different spacings from the axis.

8. The countersink bit defined in claim 2 wherein the frustoconical surface has an apex angle of more than 0° and less than 180°.

9. The countersink bit defined in claim 2 wherein the frustoconical surface has an apex angle of more than 110° and less than 130°.

10. The countersink bit defined in claim 2 wherein the body forms the entire head.

11. The countersink bit defined in claim 10 wherein the head and shaft have axially interfitting and complementary formations.

12. The countersink bit defined in claim 11 wherein the formations include an axial projection of predetermined axial length, an axially open seat of predetermined axial depth shorter than the length and having a rim, and a shoulder fixed relative to the projection and bearing axially on the rim.

13. The countersink bit defined in claim 12 wherein the head and shaft form at a base of the seat and end of the projection a chamber, the shaft being formed of metal with an axial large-diameter feed passage opening into the chamber and the head being formed with a plurality of smaller-diameter branch passages extending from the chamber to the surface, the bit further comprising
means for forcing a coolant liquid through the passages to the surface.

14. The countersink bit defined in claim 12, further comprising
an adhesive between the rim and the shoulder.

15. The countersink bit defined in claim 12, further comprising
a plurality of set screws engaged radially through the seat into the projection.

16. The countersink bit defined in claim 12 wherein the projection is formed on the shaft and the seat on the head.

17. The countersink bit defined in claim 2 wherein the shaft, the head, and the body are unitarily formed of the same axially relatively incompressible torque-transmitting material.

18. The countersink bit defined in claim 2 wherein the shaft is further unitarily formed centered on the axis with a boring tool projecting axially past the head.

19. The countersink bit defined in claim 2 wherein the layer of grinding material is adhesively secured to the surface.

20. The countersink bit defined in claim 19 wherein the layer of grinding material is sintered.
